(19) United States
(12) Patent Application Publication
(10) Pub. No.: US 2019/0126307 A1
(43) Pub. Date: May 2, 2019

(54) FLUID DISPENSING MACHINE

(71) Applicant: Langeman Manufacturing Limited, Kingsville (CA)

(72) Inventors: Gary D. Langeman, Kingsville (CA); Harpreet Singh, Leamington (CA)

(21) Appl. No.: 16/170,745

(22) Filed: Oct. 25, 2018

(30) Foreign Application Priority Data
Oct. 31, 2017 (CA) 2984344

(51) Int. Cl. B05B 12/02

(52) U.S. Cl. CPC B05B 12/02

(57) ABSTRACT

A machine for dispensing fluid having digital codes stored in in the machine that are unique to the machine. Each code specifies a volume of fluid. The machine includes a fluid tank, dispensing unit, and control unit. The dispensing unit is configured to dispense the fluid when it is enabled. The control unit controls the dispensing, receiving a digital code from a user and verifying whether the code corresponds to a stored code. If it does, the control unit enables dispensing of the fluid. The control unit determines the volume of the fluid specified by the received code and enables the dispensing unit to dispense the fluid, but when the dispensing unit has dispensed the volume of the fluid specified by the received code, the control unit then disables the dispensing unit so that no more fluid can be dispensed until another valid code is provided to the machine.

### FIELD OF THE INVENTION

The present invention relates generally to machines for dispensing fluids, and more particularly to machines for dispensing fluid coatings for coating objects and surfaces in controlled volumes.

### BACKGROUND OF THE INVENTION

Systems for spray applied coatings are a combination of chemistry also referred to as material science and machinery used to apply these materials. There is a defined relationship to the performance of the end product having to do with the precision with which the plural component chemistry is blended and afterwards dispensed by the machinery. To be more specific, the chemistry must be accurately delivered to a mixing head or spray gun where the two separate materials are mixed and then dispensed precisely and if the chemical reaction is not completed as intended, the physical properties will be outside of the specification for tensile strength, elongation, abrasion resistance and other parameters that are necessary for a successful end product.

Many companies sell proprietary systems to their customers and are guaranteed specific results for these products based on using their proprietary system of machinery and chemistry. These systems can be for such end products as coatings for truck bed liners, protective coatings for boat decks, concrete floors, wood decks, etc.

A growing problem of increasing concern to such sellers of systems is that the customer who purchases one of these proprietary systems can be influenced by third party manufacturers of chemicals to use their chemistry, often in violation of agreements, but at any rate, the seller of the system is rarely made aware that someone else's chemicals have been used in the customer's process and yet the seller is still required by the customer to offer technical support for the machine and for the process, even in the event that the chemicals being used by the customer are not purchased from the seller as intended.

### SUMMARY OF THE INVENTION

A primary purpose of the invention is to limit the use of a dispensing apparatus by an authorized user to a specific volume throughput of material, based on the actual amount of material purchased by the authorized user of the apparatus.

The present invention is a dispensing machine for dispensing fluid. The dispensing machine has multiple digital codes stored in a digital memory in the machine. Each digital code is unique to the dispensing machine, and each digital code specifies a volume of the fluid. The dispensing machine includes a fluid tank for holding the fluid, a dispensing unit, and a control unit. The dispensing unit is in fluid communication with the fluid tank and is configured to dispense the fluid when the dispensing unit is enabled. The control unit includes a computer processor for controlling the dispensing of the fluid by the dispensing unit. The control unit is operatively coupled to the dispensing unit so that the software running on the computer processor can control the dispensing unit. The control unit is configured to receive a first digital code provided by a user of the dispensing machine and then verify whether the first digital code corresponds to one of the digital codes stored in the dispensing machine. If the first digital code corresponds to one of the digital codes stored in the dispensing machine then the control unit enables dispensing of the fluid as follows. The control unit determines the volume of the fluid specified by the first digital code and enables the dispensing unit to dispense the fluid, but when the dispensing unit has dispensed the volume of the fluid specified by the first digital code, the control unit then disables the dispensing unit so that no more fluid can be dispensed until another valid digital code is provided to the machine.

The dispensing unit preferably includes a positive displacement gear pump, a servo motor and a servo motor encoder, where the servo motor drives the pump and causes the pump to dispense a fixed volume of the fluid during each revolution of the servo motor. The control unit calculates how much fluid has been dispensed based on the number of revolutions of the servo motor, and the control unit disables the dispensing unit when the calculated volume of fluid dispensed since the dispensing unit was last enabled equals the volume of the fluid specified by the first digital code.

The control unit is preferably configured to verify that the first digital code has not previously been previously used to enable the dispensing unit, and the control unit is preferably configured to enable the dispensing unit to dispense the fluid only if the first digital code corresponds to one of the plurality of digital codes stored in the dispensing machine and the first digital code has not previously been used by the control unit to enable the dispensing unit.

The control unit may be further configured to receive another digital code provided by the user of the dispensing machine and then verify whether the other digital code corresponds to one of the digital codes stored in the dispensing machine and that the other digital code has not previously been used by the control unit to enable the dispensing unit. If the other digital code corresponds to one of the digital codes stored in the dispensing machine, and the other digital code has not previously been used by the control unit to enable the dispensing unit, then the control unit enables dispensing of the fluid as follows. The control unit determines the volume of the fluid specified by the other digital code, enables the dispensing unit to dispense the fluid, and when the dispensing unit has dispensed the volume of the fluid specified by the other digital code, the control unit disables the dispensing unit.

The digital codes may each be string of at least nine characters or nine digits.

The dispensing machine may also include a keypad operatively coupled to the control unit, so that the first digital code and other digital codes may be provided by the user of the dispensing machine using the keypad. The keypad may include a display that displays the volume of fluid that the dispensing machine has been authorized to further dispense.

The dispensing machine may also include a scanner, so that the first digital code and other digital codes may be provided to the control unit by the user scanning a barcode with the scanner.

The dispensing machine may also include a wireless interface so that the first digital code and other digital codes may be provided to the control unit by being wirelessly transmitted from a portable electronic device of the user.

The digital codes stored in the dispensing machine may be encoded using a cryptographic hash function so that verifying whether a digital code provided by the user corresponds to one of the plurality of digital codes stored in the dispensing machine entails computing a hash of the a digital code provided by the user using the cryptographic hash function and comparing the hash of the a digital code provided by the user with the hashes of the digital codes stored in the dispensing machine.

The digital codes stored in the dispensing machine may be encrypted using a secret key so that verifying whether a digital code provided by the user corresponds to one of the digital codes stored in the dispensing machine entails decrypting the digital code provided by the user using a public key corresponding to the secret key.

The dispensing machine may be configured to spray the fluid, and dispensing the fluid then involves spraying the fluid on an object or a surface. The fluid may be liquid resin that is sprayed on a truck bed. The fluid may be a coating material that is sprayed on a concrete floor.

In other embodiments, the invention provides a dispensing machine having an identifier that is unique to the dispensing machine. The dispensing machine includes a fluid tank for holding the fluid, a dispensing unit, and a control unit. The dispensing unit is in fluid communication with the fluid tank and is configured to dispense the fluid when the dispensing unit is enabled. The control unit includes a computer processor for controlling the dispensing of the fluid by the dispensing unit. The control unit is operatively coupled to the dispensing unit so that the software running on the computer processor can control the dispensing unit. The control unit is configured to receive a first digital code provided by a user of the dispensing machine where the digital code securely encodes a first volume of the fluid and a dispensing machine identifier. The control unit then decodes the digital code and verifies that the dispensing machine identifier in the first digital code corresponds to the unique identifier of the dispensing machine. If the dispensing machine identifier in the first digital code does correspond to the unique identifier of the dispensing machine then the control unit enables the dispensing unit to dispense the fluid, and, when the dispensing unit has dispensed the first volume of fluid encoded in the first digital code, the control unit disables the dispensing unit.

In such embodiments, the first digital code may be encrypted using a secret key and the dispensing machine has a corresponding public key accessible by the computer processor of the control unit, and the computer processor decodes the first digital code by decrypting the first digital code using the public key. Another digital code may subsequently be received by the control unit, where the other digital code encodes a second volume of the fluid and the unique identifier of the dispensing machine, and the control unit allows the dispensing unit to dispense the second volume of the fluid in addition to the first volume of the fluid before disabling the dispending unit. The other digital code may be encoded using public key cryptography, so that the other digital code is encrypted using a secret key that was also used to encrypt the first digital code, and the dispensing machine has a corresponding public key accessible by the computer processor of the control unit. Then the computer processor decodes the other digital code by decrypting the other digital code using the public key.

### BRIEF DESCRIPTION OF THE DRAWINGS

FIG. 1 is a block diagram of the fluid dispensing machine.

### DETAILED DESCRIPTION OF THE INVENTION

The invention disclosed herein is a practical means of controlling dispensing machinery in order to prevent the undesirable result of customers using non-conforming fluid materials that are dispensed by the dispensing machine. A vendor may sell a dispensing machine, such as a machine that dispenses liquid plastic or other coating fluid that is sprayed on a surface or object, such as a truck bed, at a favourable price in order to make profit from providing the fluid dispensed by the machine. While contractual mechanisms can be used to attempt to force the user of the machine to purchase the fluid from the vendor of the dispensing machine, the vendor may not be aware that purchasing of fluids from third-part vendors is happening, and pursuing legal action is expensive. As a result, third party vendors may offer such fluid materials, which are typically inferior in quality or incompatible with the machine and/o its dispensing settings and ratios, at a significantly lower price than the vendor of the dispensing machine, thus effectively preventing the vendor of the dispensing machine from charging a premium for the fluid to compensate for higher quality of the material and the lower pricing of the dispensing machine.

The dispensing machine disclosed herein uses a servo motor to drive dispensing pumps and a computer control for the servo motor that limits the output of the pumps to a defined volume of material specified by a code that must be entered into the computer control. The code may be entered into the computer by the customer (user) using a numeric keypad interface, for example. If the computer then identifies the code as being correct, it enables the machine to dispense a pre-determined volume of material. After that pre-determined amount (volume) of fluid has been dispensed, unless a new code specifying an additional amount of fluid has already been entered, the computer disables the dispensing unit of the machine which dispenses fluid. Each particular machine's computer control is preprogrammed at the factory to accept specific codes which are unique to that machine and are created using an algorithm so as to be practically impossible for anyone other than the original manufacture to control.

When a customer who has purchased a system from the vendor of the dispensing machine (or a third party licensed by the vendor of the dispensing machine) orders, for example, 100 gallons of chemical for the customer's machine, an invoice for 100 gallons will be provided to the customer with a digital code that the customer must enter correctly, for example by use of a keypad on or attached to the machine. The code may be, for example, a nine-digit numeric code found on the invoice. Once the code is entered correctly, the machine's computer control unit will recognize the code and allow the drive system's servo motor in the dispensing unit of the machine to drive the pumps for a specific number of rotations that equate to dispensing of 100 gallons of chemical. If the customer has used all 100 gallons of the material, the control system of the machine will indicate, for example by means of a flashing light signal, that it will not start until a new code is entered.

When the customer places an order for chemical (i.e. fluid), the code is created by the vendor that will enable the computer control of the customer's machine to dispense up to the exact volume of chemical purchased. This may be done, for example, by selecting the next code in a stored list of codes for the machine for the purchased volume of chemical that has not yet been used, and then marking the selected code as having been used.

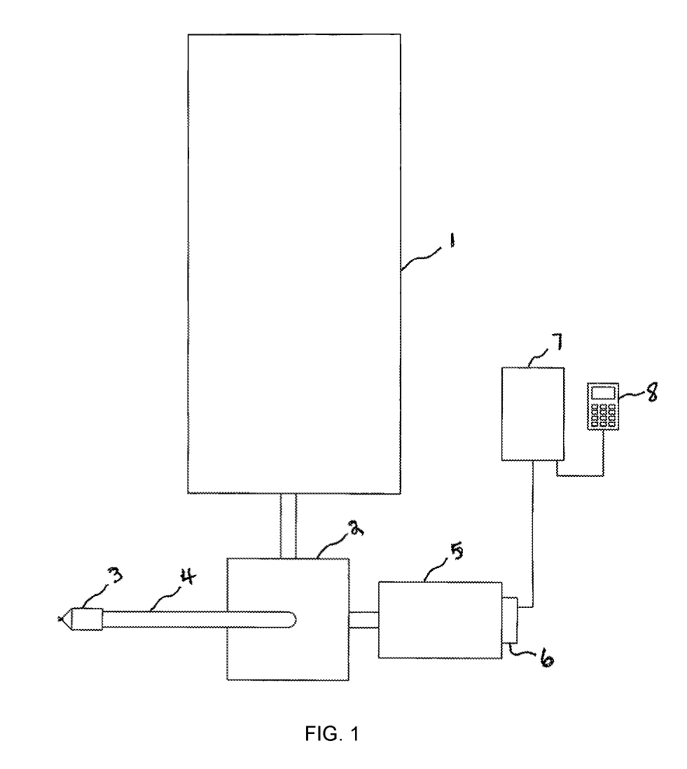

One embodiment of the invention is shown in FIG. 1.

In a preferred embodiment, the invention is a dispensing machine having a holding tank 1, metering means, dispensing means, drive means, drive control means, data interface means, computer software means from which an encrypted code can be produced, enabling authorized use of the apparatus.

In an example embodiment, the holding tank is a ten-gallon fluid tank, the metering means is a positive displacement gear pump 2, the dispensing means is a spray gun 3 connected to the gear pump 2 by a fluid hose 4, the drive means is a servo motor 5 coupled directly to the gear pump 2, the drive control means is a servo motor computer control 7 with proprietary firmware, the data interface is an alpha-numeric keypad and display module 8 connected to the servo control computer 7 via a USB port and the computer software means is a desktop computer running a software algorithm designed to create encrypted codes that coincide with codes preloaded in the memory of the servo motor computer control.

When the customer, also referred to as the user of the machine, purchases, for example, ten gallons of liquid resin from the supplier of the system, the supplier generates a digital code which accompanies the invoice and material supplied to the customer. The digital code may be, for example, a certain number, such as 9 or 12, of digits or alpha-numeric characters. After receiving the code, the customer enters the code through use of the interface keypad and display module 8 of the machine. Once verified as compatible, the machine is then enabled to dispense ten gallons of resin. The servo motor 5 that drives the positive displacement pump 2 produces the necessary feedback to the servo drive controller 7 which, by calculating the precise number of revolutions of the pump will then permit continuous or intermittent use of the machine until precisely ten gallons of resin has been dispensed. At that point, the computer control will not allow the machine to run until a new code has been entered.

The codes accepted by the machine controller are created to be unique to that machine and will only coincide with the encrypted codes programmed into the machine controller. The codes preloaded into the machine controller are also a component of the algorithm used by the desktop computer used to create the coinciding codes for that specific machine. Each new code created can only be used once and must be used in the sequence that they are produced. The codes can also be created to allow the machine to dispense different volumes of material. For instance, the user may purchase two gallons of material instead of ten, for which a code is generated for the machine that will coincide with the preset algorithm of the machine controller. The supplier may allow the user to purchase various sizes containers or volumes of material.

Generally a large number (such as more than 1000) of digital codes unique to a machine are downloaded into memory in the machine at the factory. The manufacturer of the machine (or a licensee) normally offers the fluids for sale in a number of set volumes, such as 10 gallons, 20 gallons, 60 gallons, 120 gallons and 240 gallons, so a set of codes corresponding to each volume are generated and downloaded. For example, 10, 20, 60, 120 and 240 gallons may be encoded by the numbers 1, 2, 3, 4, and 5. The number of codes may be selected, for example, so that the set of codes for a given volume correspond to a greater total volume of fluid than is expected to be dispensed by the machine over its lifetime. If necessary, additional codes may later be downloaded also.

A simple but effective approach, for example, is to generate 9-digit codes that use one digit to encode the volume of fluid and 8 digits to encode a machine specific purchase number. The codes are then encrypted, for example using a cryptographic hash function, or using a secret key. Where a hash function is used, only the hashes of the digital codes are stored in the machine and the machine determines that an entered code matches one of the stored codes by computing the hash of the entered code and comparing it to the stored hashes. Once a code is verified and used to enable the machine to dispense fluid, the stored code is marked as having been used, and will not be considered valid by the machine if that same code is entered again. The 8-digit serial numbers can be generated in various ways. For example, one could combine the machine's unique serial number with a set of nonces (for example, the integers 1 to 10,000), and then calculate an 8-digit hash of the serial number combined with each nonce. After pre-computing a large number, such as 10,000, up front, the system can readily verify that there are no collisions (i.e. that all the hashes differ from each other)

When the above approach is used where the digital code consists of a 1 digit code specifying the volume of fluid, and an 8-digit hash unique to the machine, then there is generally no need for any further encryption of the 9-digit code since others will not be able to generate valid codes. However, a further level of hashing/encryption, as discussed herein, may be employed to protect against the possibility of an attacker gaining access to the codes stored in the machine.

The machine control interface displays to the user the amount of fluid that remains to be dispensed before the machine will be disabled so that it can dispense no more fluid and the last code used is no longer valid. That function is related to the feedback produced by the servo motor encoder that relays accurate information relating to the number of revolutions that it makes. A fixed, known volume of material is output/dispensed for each revolution of the servo motor so that the volume of fluid dispensed can be calculated as the known fixed amount multiplied by the number of revolutions of the servo motor. The number of revolutions of the servo motor is in direct relationship with the volume of material metered by the positive displacement gear pump, thereby computed by the servo motor computer controller. That information is accessible by means of the control interface keypad and display.

In a preferred embodiment, the control display shows the user the last three codes that were entered so that there is no question that the codes were entered successfully. The aggregate number of units remaining to be dispensed is also displayed when the user enters a specific 5-digit code to access that information.

If the customer enters the wrong code more than a certain number, such as five, times, the control will default to a customer service “reset status” whereby a light will come on indicating that the user must call customer service. The manufacturer's customer service team can then give the customer a reset code to once again permit access. The machine may also be pre-loaded with a number (e.g. 200 or more) maintenance/reset codes, such as 6-digit codes, which may also be encrypted and each used a single time to put the machine into maintenance/diagnostic mode or reset the machine. In maintenance mode, various information can be retrieved, such as when the machine was used, the duration of time, the amount of product/chemical used per each time, the aggregate amount of product used from the initial startup, the last 3 codes entered by the user and the last code entered by the user. Such information may also be available to the user by the user entering a user-specific code, such as a 5-digit code provided by the manufacturer.

In general, the elements of the machine that dispense the fluid may be referred to as the dispensing unit. In the depicted embodiment, the dispensing unit includes a positive displacement gear pump 2, servo motor 5, servo motor encoder 6, and a spray gun 3. The elements of the machine that control the dispensing of the fluid by the dispensing unit may be referred to as the control unit. In the depicted embodiment, the control unit includes the servo motor computer controller 7 and the control interface keypad display 8.

In other embodiments, the digital code encodes at least two elements. The first is an identifier that is unique to the dispensing machine, and which is stored in the control unit. The unique identifier may be any suitable identifier, such as a serial number that is generated and loaded into each machine as they are produced. No two instances of the machine have the same identifier. The second element in the digital code is the amount, or volume, of fluid that the user has been authorized to dispense using the machine.

It should be noted that the approach described herein does not require checking that the user is dispensing fluid that was purchased from, or authorized by, any particular source. However, only the maker of the machine, or those who the maker has authorized and instructed, are able to generate a digital code encoding the machine's unique identifier and the amount of fluid that has been purchased. This can be ensured by encoding the information using encryption.

For example, public key cryptography may be used, where the manufacturer has a secret key with a corresponding public key that is stored in each machine. Although someone with access to each machine may be able to access the public key, this is of no benefit to them. The information is encrypted using the manufacturer's secret key (the manufacture may use multiple sets of secret/public keys) and only the manufacturer (or a licensee) has access to that secret key. The machine is designed so that dispensing is only enabled after the machine successfully decrypts the digital code using the public key and verifies that the unique identifier in the code corresponds to the particular machine.

The digital code generally further includes information so that the code is different from any other codes that have been previously produced, or will be subsequently produced. The system that generates the codes keeps a record of the previously generated codes for each machine and so can readily ensure that the same code is not generated twice. This can be achieved, for example, simply by including a number, N, in the code indicating that this is the Nth such code generated for a particular machine, or possibly for all such machines or machines of a certain class, where the number is encrypted along with the other information into the digital code. Each machine can store information regarding previously entered codes (such as a copy of each code previously used) and thereby confirm for each new code entered that the code has not been used previously.

In general, an arbitrary number of codes can be generated for, and used by, a particular machine to allow dispensing of an arbitrary amount of fluid, where the total amount dispensed is under the control of the entity generating the codes.

A new code may be entered after the amount of fluid specified in the previous code has been dispensed and the dispensing unit has been disabled, thereby re-enabling the machine to dispense the amount of fluid indicated in the new code. The machine may also allow a new code to be entered while some amount of fluid from one or more previously entered codes has yet to be dispensed. For example, if the user entered a first code for 10 gallons, dispensed 8 gallons, and then entered a new code for another 10 gallons, after verifying the new code, the control unit would increment the amount of fluid still to be dispensed to be 12 gallons.

While a keypad with a display may be used to enter the digital codes, various other methods are possible. For example, the vendor of the fluid may give the user a barcode (2D, 3D or otherwise), for example on the invoice or in an electronic message that can be displayed on the user's phone, and the dispensing machine may have a camera or barcode scanner that can read the barcode and extract the digital code. Other methods include having a wireless interface in the machine (e.g. Bluetooth or Wi-Fi), where the vendor provides the digital code electronically to the user to be stored on the user's smartphone so that it can be transmitted wirelessly to the dispensing machine.

If a code provided to a dispensing machine is decoded and the portion of the code that should be the unique identifier of the machine does not match the unique identifier stored in the machine, the code will not be accepted and the machine will not be enabled if it is currently disabled. An indication that the code is invalid is provided to the user, such as on the display associated with the keypad.

Where public key encryption is used to encode the digital codes, there is no need to keep the machine's unique identifier secret. An attacker who gains access to the unique identifier cannot generate a valid encoded digital code because encoding the digital code requires access to the vendor's secret key. In some embodiments though, for greater security, the machine's unique identifier may not ever be stored directly in the machine in a manner that the unique identifier could be retrieved by a person who gains physical access to the machine. For example, the unique identifier may be encoded using a cryptographic hash function (like the manner in which passwords are typically stored in computer systems) and only the hashed value stored in the machine. Such a hashed value cannot practically be used to derive the unique identifier. The vendors system that generates the digital codes includes the un-hashed version of the unique identifier, but the digital code is encrypted. After the control unit decrypts a digital code and extracts the unique identifier from it, the control unit then computes the hash of the unique identifier and compare the hash with the stored hash value. The decrypted unique identifier is preferably never stored in any non-volatile storage in the machine.

In some embodiments, a greater degree of security may be achieved by ensuring that the digital codes are not directly stored in the machine in non-volatile memory where the public key that can be used to decrypt them is stored. The machine need only keep sufficient information so that it can determine whether the same code has already been used. For example, hashes of the previously entered codes may be stored, or where the digital codes include serial numbers for each code for a particular machine, only the serial number need be retained in the machine.

Although a system including only hardware is possible, the processing done by the control unit is preferably performed by software stored in non-volatile memory in the machine that executes on a computer processor in the control unit.

As will be evident to skilled persons, the invention also provides a method of controlling the amount of fluid dispensed by a fluid dispensing machine. The method is implemented by the control unit of the machine, as described above.

It should be noted that the fluid described herein make be a combination of two or more chemicals mixes. If some cases, the machine's fluid tank may have multiple sections so that two or more types of fluids may be stored separately and then when the machine dispenses the fluid, it combines the separate fluids in a pre-determined ratio while dispensing the combined fluid.

In general herein, verifying a code or an identifier means that it corresponds to a code or identifier stored in the machine. As described above, in some cases, as discussed, the code or identifier can be directly compared to the stored value and the code or identifier is verified if it equals the stored value. In other cases, it may be necessary to either compute a cryptographic hash of the code or identifier or decrypt the code or identifier and then compare the hash or decrypted value with the stored value(s) and the code or identifier is then verified if the hashed and decrypted value equals the stored value.

Methods and systems relevant to the present invention are described in U.S. Pat. Nos. 7,025,286, 6,755,348, 5,388,761, 6,131,823, and 7,318,554, all of which are hereby incorporated herein by reference in their entirety

Generally, a computer, computer system, computing device, client or server, as will be well understood by a person skilled in the art, includes one or more than one electronic computer processor, and may include separate memory, and one or more input and/or output (I/O) devices (or peripherals) that are in electronic communication with the one or more processor(s). The electronic communication may be facilitated by, for example, one or more busses, or other wired or wireless connections. In the case of multiple processors, the processors may be tightly coupled, e.g. by high-speed busses, or loosely coupled, e.g. by being connected by a wide-area network.

A computer processor, or just “processor”, is a hardware device for performing digital computations. It is the express intent of the inventors that a “processor” does not include a human; rather it is limited to be an electronic device, or devices, that perform digital computations. A programmable processor is adapted to execute software, which is typically stored in a computer-readable memory. Processors are generally semiconductor based microprocessors, in the form of microchips or chip sets. Processors may alternatively be completely implemented in hardware, with hard-wired functionality, or in a hybrid device, such as field-programmable gate arrays or programmable logic arrays. Processors may be general-purpose or special-purpose off-the-shelf commercial products, or customized application-specific integrated circuits (ASICs). Unless otherwise stated, or required in the context, any reference to software running on a programmable processor shall be understood to include purpose-built hardware that implements all the stated software functions completely in hardware.

Multiple computers (also referred to as computer systems, computing devices, clients and servers) may be networked via a computer network, which may also be referred to as an electronic network or an electronic communications network. When they are relatively close together the network may be a local area network (LAN), for example, using Ethernet. When they are remotely located, the network may be a wide area network (WAN), such as the internet, that computers may connect to via a modem, or they may connect to through a LAN that they are directly connected to.

Computer-readable memory, which may also be referred to as a computer-readable medium or a computer-readable storage medium, which terms have identical (equivalent) meanings herein, can include any one or a combination of non-transitory, tangible memory elements, such as random access memory (RAM), which may be DRAM, SRAM, SDRAM, etc., and nonvolatile memory elements, such as a ROM, PROM, FPROM, OTP NVM, EPROM, EEPROM, hard disk drive, solid state disk, magnetic tape, CDROM, DVD, etc.) Memory may employ electronic, magnetic, optical, and/or other technologies, but excludes transitory propagating signals so that all references to computer-readable memory exclude transitory propagating signals. Memory may be distributed such that at least two components are remote from one another, but are still all accessible by one or more processors. A nonvolatile computer-readable memory refers to a computer-readable memory (and equivalent terms) that can retain information stored in the memory when it is not powered. A computer-readable memory is a physical, tangible object that is a composition of matter. The storage of data, which may be computer instructions, or software, in a computer-readable memory physically transforms that computer-readable memory by physically modifying it to store the data or software that can later be read and used to cause a processor to perform the functions specified by the software or to otherwise make the data available for use by the processor. In the case of software, the executable instructions are thereby tangibly embodied on the computer-readable memory. It is the express intent of the inventor that in any claim to a computer-readable memory, the computer-readable memory, being a physical object that has been transformed to record the elements recited as being stored thereon, is an essential element of the claim.

Software may include one or more separate computer programs configured to provide a sequence, or a plurality of sequences, of instructions to one or more processors to cause the processors to perform computations, control other devices, receive input, send output, etc.

It is intended that the invention includes computer-readable memory containing any or all of the software described herein. In particular, the invention includes such software stored on non-volatile computer-readable memory that may be used to distribute or sell embodiments of the invention or parts thereof.

The abbreviation mm as used herein refers to millimetres (or in the US, “millimeters”). The abbreviation cm as used herein refers to centimetres (or in the US, “centimeters”).

Where, in this document, a list of one or more items is prefaced by the expression “such as” or “including”, is followed by the abbreviation “etc.”, or is prefaced or followed by the expression “for example”, or “e.g.”, this is done to expressly convey and emphasize that the list is not exhaustive, irrespective of the length of the list. The absence of such an expression, or another similar expression, is in no way intended to imply that a list is exhaustive. Unless otherwise expressly stated or clearly implied, such lists shall be read to include all comparable or equivalent variations of the listed item(s), and alternatives to the item(s), in the list that a skilled person would understand would be suitable for the purpose that the one or more items are listed. Unless expressly stated or otherwise clearly implied herein, the conjunction “or” as used in the specification and claims shall be interpreted as a non-exclusive “or” so that “X or Y” is true when X is true, when Y is true, and when both X and Y are true, and “X or Y” is false only when both X and Y are false.

The words “comprises” and “comprising”, when used in this specification and the claims, are used to specify the presence of stated features, elements, integers, steps or components, and do not preclude, nor imply the necessity for, the presence or addition of one or more other features, elements, integers, steps, components or groups thereof.

It should be understood that the above-described embodiments of the present invention, particularly, any “preferred” embodiments, are only examples of implementations, merely set forth for a clear understanding of the principles of the invention. Many variations and modifications may be made to the above-described embodiment(s) of the invention as will be evident to those skilled in the art. That is, persons skilled in the art will appreciate and understand that such modifications and variations are, or will be, possible to utilize and carry out the teachings of the invention described herein.

The scope of the claims that follow is not limited by the embodiments set forth in the description. The claims should be given the broadest purposive construction consistent with the description and figures as a whole.

What is claimed is:

1. A dispensing machine for dispensing fluid, the dispensing machine having a plurality of digital codes stored therein, each digital code being unique to the dispensing machine, each digital code specifying a volume of the fluid, the dispensing machine comprising:
a fluid tank for holding the fluid;
a dispensing unit in fluid communication with the fluid tank and configured to dispense the fluid when the dispensing unit is enabled; and
a control unit comprising a computer processor for controlling the dispensing of the fluid by the dispensing unit, the control unit being operatively coupled to the dispensing unit, the control unit being configured to:
receive a first digital code provided by a user of the dispensing machine;
verify whether the first digital code corresponds to one of the plurality of digital codes stored in the dispensing machine; and
if the first digital code corresponds to one of the plurality of digital codes stored in the dispensing machine then:
determine the volume of the fluid specified by the first digital code;
enable the dispensing unit to dispense the fluid, and
when the dispensing unit has dispensed the volume of the fluid specified by the first digital code, disable the dispensing unit.

2. The dispensing machine of claim 1, wherein the dispensing unit comprises a positive displacement gear pump, a servo motor and a servo motor encoder, wherein the servo motor drives the pump and causes the pump to dispense a fixed volume of the fluid during each revolution of the servo motor.

3. The dispensing machine of claim 2, wherein the control unit calculates how much fluid has been dispensed based on the number of revolutions of the servo motor, and the control unit disables the dispensing unit when the calculated volume of fluid dispensed since the dispensing unit was last enabled equals the volume of the fluid specified by the first digital code.

4. The dispensing machine of claim 1, wherein the control unit is configured to verify that the first digital code has not previously been previously used to enable the dispensing unit, and the control unit is configured to enable the dispensing unit to dispense the fluid only if the first digital code corresponds to one of the plurality of digital codes stored in the dispensing machine and the first digital code has not previously been used by the control unit to enable the dispensing unit.

5. The dispensing machine of claim 1, wherein the control unit is further configured to:
receive another digital code provided by the user of the dispensing machine;
verify whether the other digital code corresponds to one of the plurality of digital codes stored in the dispensing machine and that the other digital code has not previously been used by the control unit to enable the dispensing unit; and
if the other digital code corresponds to one of the plurality of digital codes stored in the dispensing machine, and the other digital code has not previously been used by the control unit to enable the dispensing unit, then:
determine the volume of the fluid specified by the other digital code;
enable the dispensing unit to dispense the fluid, and
when the dispensing unit has dispensed the volume of the fluid specified by the other digital code, disable the dispensing unit.

6. The dispensing machine of claim 1, wherein the first digital code is a string of at least nine characters.

7. The dispensing machine of claim 1, wherein the dispensing machine further comprises a keypad operatively coupled to the control unit, and the first digital code is provided by the user of the dispensing machine using the keypad.

8. The dispensing machine of claim 7, wherein the keypad comprises a display that displays the volume of fluid that the dispensing machine has been authorized to further dispense.

9. The dispensing machine of claim 1, wherein the dispensing machine further comprises a scanner, and the first digital code is provided to the control unit by the user scanning a barcode with the scanner.

10. The dispensing machine of claim 1, wherein the dispensing machine further comprises a wireless interface and the first digital code is provided to the control unit by being wirelessly transmitted from a portable electronic device of the user.

11. The dispensing machine of claim 1, wherein the plurality of digital codes stored in the dispensing machine are encoded using a cryptographic hash function and verifying whether a digital code provided by the user corresponds to one of the plurality of digital codes stored in the dispensing machine comprises computing a hash of the a digital code provided by the user using the cryptographic hash function and comparing the hash of the a digital code provided by the user with the hashes of the plurality of digital codes stored in the dispensing machine.

12. The dispensing machine of claim 1, wherein the plurality of digital codes stored in the dispensing machine are encrypted using a secret key, and verifying whether a digital code provided by the user corresponds to one of the plurality of digital codes stored in the dispensing machine comprises decrypting the digital code provided by the user using a public key corresponding to the secret key.

13. The dispensing machine of claim 1, wherein the dispensing machine is configured to spray the fluid, and dispensing the fluid comprises spraying the fluid on an object or a surface.

14. The dispensing machine of claim 13, wherein the fluid is liquid resin that is sprayed on a truck bed.

15. The dispensing machine of claim 13, wherein the fluid is a coating material that is sprayed on a concrete floor.

16. A dispensing machine having an identifier that is unique to the dispensing machine, the dispensing machine comprising:
a fluid tank for holding fluid;
a dispensing unit in fluid communication with the fluid tank and configured to dispense the fluid; and
a control unit comprising a computer processor for controlling the dispensing of the fluid by the dispensing unit, the control unit being operatively coupled to the dispensing unit, the control unit being configured to:
receive a first digital code provided by a user of the dispensing machine, the digital code encoding a first volume of the fluid and a dispensing machine identifier;
decode the digital code;
verify that the dispensing machine identifier in the first digital code corresponds to the unique identifier of the dispensing machine; and
if the dispensing machine identifier in the first digital code corresponds to the unique identifier of the dispensing machine then:
enable the dispensing unit to dispense the fluid, and
when the dispensing unit has dispensed the first volume of fluid encoded in the first digital code, disable the dispensing unit.

17. The dispensing machine of claim 16, wherein the first digital code is encoded using public key cryptography, wherein the first digital code is encrypted using a secret key and the dispensing machine has a corresponding public key accessible by the computer processor of the control unit, and the computer processor decodes the first digital code by decrypting the first digital code using the public key.

18. The dispensing machine of claim 16, wherein another digital code may subsequently be received by the control unit, wherein the other digital code encodes a second volume of the fluid and the unique identifier of the dispensing machine, and the control unit is further configured to allow the dispensing unit to dispense the second volume of the fluid in addition to the first volume of the fluid before disabling the dispending unit.

19. The dispensing machine of claim 22, wherein the other digital code is encoded using public key cryptography, wherein the other digital code is encrypted using a secret key that was also used to encrypt the first digital code, and the dispensing machine has a corresponding public key accessible by the computer processor of the control unit, and the computer processor decodes the other digital code by decrypting the other digital code using the public key.
